(19) United States
(12) Patent Application Publication
(10) Pub. No.: US 2026/0084432 A1
(43) Pub. Date: Mar. 26, 2026

(54) LIQUID EJECTING APPARATUS, CONTROL METHOD FOR THE SAME, AND MEDIUM

(71) Applicant: BROTHER KOGYO KABUSHIKI KAISHA, Nagoya (JP)

(72) Inventor: Satoru ARAKANE, Nagoya (JP)

(21) Appl. No.: 19/331,121

(22) Filed: Sep. 17, 2025

(30) Foreign Application Priority Data
Sep. 20, 2024 (JP) 2024-163883
Aug. 18, 2025 (JP) 2025-135596

(51) Int. Cl. B41J 2/185; B41J 2/045; B41J 2/17; B41J 2/175

(52) U.S. Cl. CPC B41J 2/185; B41J 2/04573; B41J 2/04593; B41J 2/1707; B41J 2/17546; B41J 2/17563; B41J 2/04581; B41J 2002/1856

(57) ABSTRACT

A liquid ejecting apparatus includes a head, a receiver, a recovery channel, and a controller. The controller causes the liquid ejecting apparatus to perform a recovering process of feeding liquid from the receiver to the liquid channel; a first determining process of determining whether a first condition is satisfied, the first condition representing a first increase of a liquid feeding time required to feed a predetermined amount of liquid to the liquid channel; and a recording process. In response to determining that the first condition is satisfied, the controller causes the liquid ejecting apparatus to perform, in the recording process, at least one of: a first control in which a recording time with respect to a unit area of the recording medium is longer, or second control in which an ejection amount of liquid with respect to the unit area of the recording medium is less.

### REFERENCE TO RELATED APPLICATIONS

This application claims priority from Japanese Patent Application No. 2024-163883 filed on Sep. 20, 2024 and Japanese Patent Application No. 2025-135596 filed on Aug. 18, 2025. The entire contents of the priority applications are incorporated herein by reference.

### BACKGROUND ART

As an example of a liquid ejecting apparatus including a head and a receiving part, a known ink-jet printer employs a technique in which waste ink discharged from nozzles of the ink-jet head into a nozzle cap is returned to an ink tank via a switching valve for reuse.

### SUMMARY

Reused ink and unused ink rarely have an identical composition. For example, reused ink is highly likely to have higher viscosity and contain more foreign matter than the unused ink. Therefore, in the above technique, ink might not flow smoothly from the nozzle cap to the ink-jet head, and the ink might not be supplied to the ink-jet head in time for ejection. In this case, image streaking might occur, leading to deterioration of image quality.

Further, for example, in a configuration where a filter is disposed in a channel connecting the nozzle cap and the ink tank, repeated reuse of ink will increase the amount of the foreign matter accumulated on the filter. Also, in this case, ink might not smoothly flow from the nozzle cap to the ink-jet head. As a result, ink might not be supplied to the head in time for ejection, resulting in occurrence of image streaking and deterioration of image quality.

Furthermore, in a case where recording is not performed for a predetermined time or longer, the flow of the ink in the head stagnates, which results in an increase in the viscosity of the ink in the head or sedimentation of the foreign matter in the head. Also in this case, ink might not be supplied to the head in time for ejection, resulting in image streaking and deterioration of image quality.

An object of the present disclosure is to provide a liquid ejecting apparatus, a control method for the liquid ejecting apparatus, and a medium each of which is capable of reducing deterioration of image quality in a configuration in which a liquid ejected from a nozzle is reused.

A liquid ejecting apparatus according to aspects of the present disclosure includes: a head having a liquid channel including a nozzle; a receiver; a recovery channel connecting the receiver and the liquid channel; and a controller that causes the liquid ejecting apparatus to perform: a recovering process of feeding liquid from the receiver to the liquid channel via the recovery channel; a first determining process of determining whether a first condition is satisfied, the first condition representing a first increase of a liquid feeding time required to feed a predetermined amount of liquid to the liquid channel via the recovery channel; and a recording process of recording an image on a recording medium by causing the head to eject liquid from the nozzle to the recording medium. In response to determining in the first determining process that the first condition is satisfied, the controller causes the liquid ejecting apparatus to perform, in the recording process, at least one of: a first control in which a recording time with respect to a unit area of the recording medium is longer than a recording time with respect to the unit area of a case where the controller determines in the first determining process that the first condition is not satisfied, or a second control in which an ejection amount of liquid with respect to the unit area of the recording medium is less than an ejection amount of a case where the controller determines in the first determining process that the first condition is not satisfied.

A control method according to aspects of the present disclosure is a control method for a liquid ejecting apparatus including a head having a liquid channel including a nozzle, a receiver, and a recovery channel connecting the receiver and the liquid channel. The method includes: a recovering process of feeding a liquid from the receiver to the liquid channel via the recovery channel; a first determining process of determining whether a first condition is satisfied, the first condition representing a first increase of a liquid feeding time required to feed a predetermined amount of liquid to the liquid channel via the recovery channel; and a recording process of recording an image on a recording medium by causing the head to eject liquid from the nozzle to the recording medium. In response to determining in the first determining process that the first condition is satisfied, causing the liquid ejecting apparatus to perform, in the recording process, at least one of: a first control in which a recording time with respect to a unit area of the recording medium is longer than a recording time with respect to the unit area of a case where the first condition is determined to be not satisfied in the first determining process, or a second control in which an ejection amount of liquid with respect to the unit area of the recording medium is less than an ejection amount of a case where the first condition is determined to be not satisfied in the first determining process.

A medium according to aspects of the present disclosure is a non-transitory and computer-readable medium storing a program executable by a controller of a liquid ejecting apparatus. The liquid ejecting apparatus includes a head having liquid channel including a nozzle; a receiver; and a recovery channel connecting the receiver and the liquid channel. The program, when executed by the controller, causing the liquid ejecting apparatus to perform: a recovering process of feeding a liquid from the receiver to the liquid channel via the recovery channel; a first determining process of determining whether a first condition is satisfied, the first condition representing a first increase of a liquid feeding time required to feed a predetermined amount of liquid to the liquid channel via the recovery channel; and a recording process of recording an image on a recording medium by causing the head to eject liquid from the nozzle to the recording medium. In response to determining in the first determining process that the first condition is satisfied, the controller causes the liquid ejecting apparatus to perform, in the recording process, at least one of: first control in which a recording time with respect to a unit area of the recording medium is longer than a recording time with respect to the unit area of a case where the controller determines in the first determining process that the first condition is not satisfied, or second control in which an ejection amount of liquid with respect to the unit area of the recording medium is less than an ejection amount of a case where the controller determines in the first determining process that the first condition is not satisfied.

According to the present disclosure, in a case where the first condition representing the first increase of the liquid feeding time is satisfied, the recording time with respect to the unit area of the recording medium lengthen and/or the liquid ejection amount with respect to the unit area of the recording medium decreases, as compared to a case where the first condition is not satisfied. With this, even in the case where the first condition representing the first increase of the liquid feeding time is satisfied, the liquid can be supplied to the head in time for the ejection, and thus, for example, streaking is less likely to occur in an image, and deterioration of image quality can be reduced. In other words, according to the present disclosure, deterioration of image quality can be reduced in a configuration wherein a liquid ejected from a nozzle is reused.

### BRIEF DESCRIPTION OF DRAWINGS

FIG. 1 is a side view of a printer.

FIG. 2 is a cross-sectional view of a head included in the printer.

FIG. 3 is a plan view of the printer.

FIG. 4 is a block diagram illustrating an electrical configuration of the printer.

FIG. 5 is a flowchart illustrating a sequence of steps for a recording setting program executed by a CPU of the printer.

FIG. 6 is a flowchart illustrating a sequence of steps for an information initializing program executed by the CPU of the printer.

### DESCRIPTION

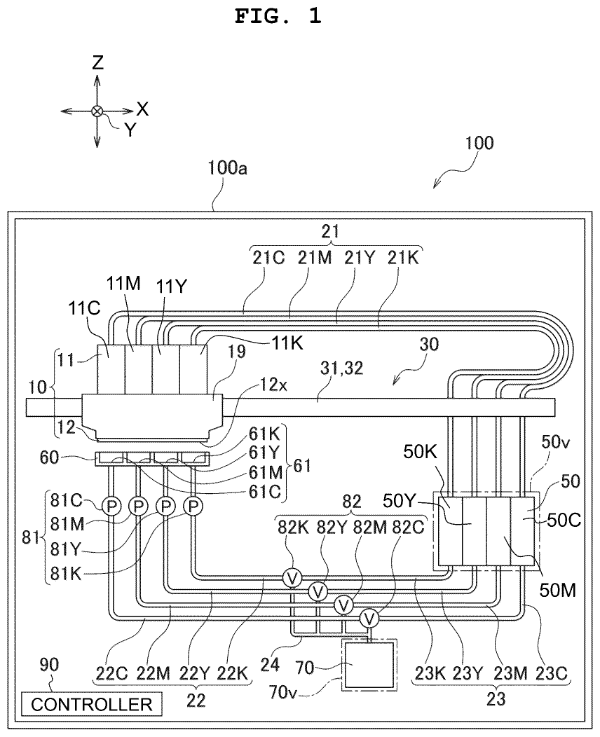

First, the overall configuration of a printer 100 according to an embodiment of the present disclosure will be described with reference to FIG. 1 to FIG. 4. In the following description, Z direction is the vertical direction, and X direction and Y direction are each the horizontal direction. Each of the X direction and the Y direction is orthogonal to the Z direction. The X direction is orthogonal to the Y direction.

The printer 100 includes a head 10, a carriage 19, a scanning mechanism 30, a cap 60, and a controller 90, as depicted in FIG. 1. The carriage 19 holds the head 10. The scanning mechanism 30 causes the carriage 19 to move in the X direction. The above-described components are located in a casing 100a of the printer 100.

The printer 100 further includes, inside the casing 100a, an accommodating part 50v capable of accommodating an ink cartridge 50 and an accommodating part 70v capable of accommodating a waste ink tank 70. The ink cartridge 50 includes an ink cartridge 50C which stores cyan ink, an ink cartridge 50M which stores magenta ink, an ink cartridge 50Y which stores yellow ink, and an ink cartridge 50K which stores black ink. The ink cartridge 50 is attachable to and detachable from the accommodating part 50v. The accommodating part 50v may be configured to accommodate a single ink cartridge 50 that integrates the four ink cartridges 50C, 50M, 50Y, and 50K. Alternatively, the accommodating part 50v may be configured to individually accommodate the four ink cartridges 50C, 50M, 50Y, and 50K included in the ink cartridge 50. The waste ink tank 70 is attachable to and detachable from the accommodating part 70v. The ink cartridge 50 is an example of a “liquid reservoir” of the present disclosure. The waste ink tank 70 is an example of a “waste liquid reservoir” of the present disclosure. The accommodating part 50v is an example of a “holder” of the present disclosure.

The head 10 includes a buffer unit 11 and a channel unit 12.

The buffer unit 11 includes a buffer unit 11C which stores the cyan ink, a buffer unit 11M which stores the magenta ink, a buffer unit 11Y which stores the yellow ink, and a buffer unit 11K which stores the black ink 11K.

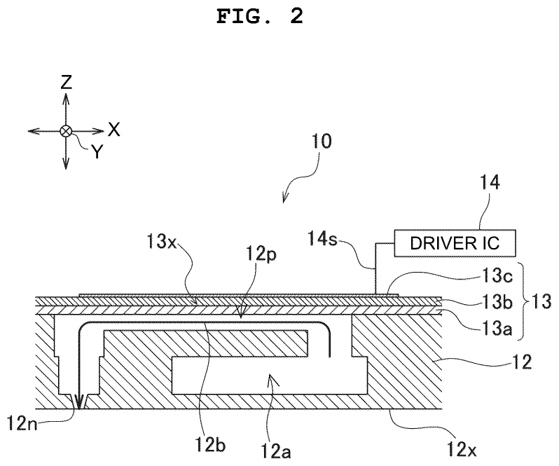

As depicted in FIG. 2, the channel unit 12 includes a common channel 12a and a plurality of individual channels 12b communicating with the common channel 12a. A combination of the common channel 12a of the channel unit 12, the individual channels 12b of the channel unit 12 and a channel of the buffer unit 11 is an example of a “liquid channel” of the present disclosure.

The common channel 12a is disposed as a plurality of common channels 12a each of which corresponds to one of the above-described colors and each of which communicates with one of the buffer units 11C, 11M, 11Y and 11K of the corresponding color (see FIG. 1). Each of the plurality of individual channels 12b is a channel extending from the outlet of the common channel 12a and reaching a nozzle 12n via a pressure chamber 12p, and has one end communicating with the common channel 12a and the other end, on the opposite side to the one end, having the nozzle 12n.

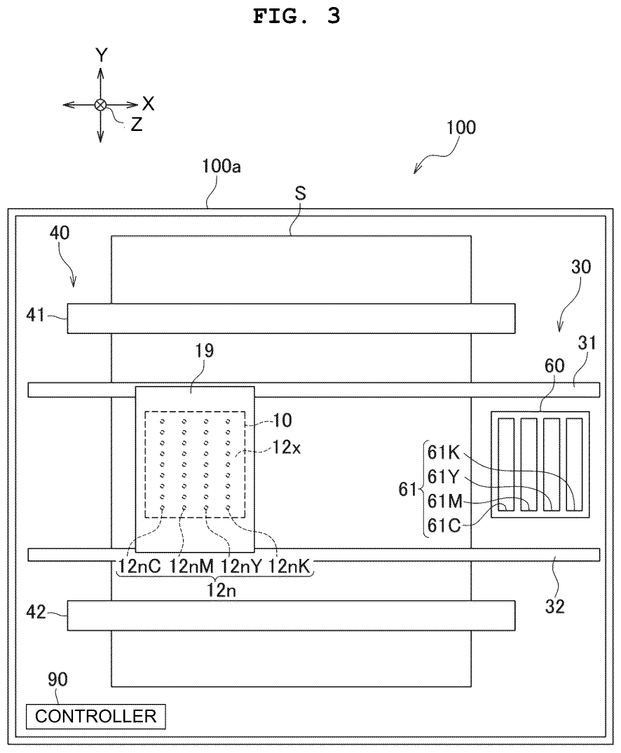

A lower surface 12x of the channel unit 12 has a plurality of nozzles 12n, as depicted in FIG. 3. The nozzles 12n are arranged in nozzle arrays. The nozzle arrays include a nozzle array in which a plurality of nozzles 12nC ejecting the cyan ink is aligned, a nozzle array in which a plurality of nozzles 12nM ejecting the magenta ink is aligned, a nozzle array in which a plurality of nozzles 12nY ejecting the yellow ink is aligned, and a nozzle array in which a plurality of nozzles 12nK ejecting black ink is aligned.

Any one of the four color inks is an example of a “first liquid” of the present disclosure, and another one of the four color inks is an example of a “second liquid” of the present disclosure. For example, the cyan ink may be an example of the “first liquid” of the present disclosure, and the magenta ink may be an example of the “second liquid” of the present disclosure. In this case, a combination of the buffer unit 11C which stores the cyan ink and the common channel 12a and the individual channels 12b communicating with the buffer unit 11C is an example of a “first liquid channel” of the present disclosure. A combination of the buffer unit 11M which stores the magenta ink and the common channel 12a and the individual channels 12b communicating with the buffer unit 11M is an example of a “second liquid channel” of the present disclosure. The nozzles 12nC are each an example of a “first nozzle” of the present disclosure, and the nozzles 12nM are each an example of a “second nozzle” of the present disclosure.

The head 10 further includes an actuator unit 13 disposed on the channel unit 12, as depicted in FIG. 2.

The actuator unit 13 includes a vibration plate 13a, a piezoelectric layer 13b, and a plurality of individual electrodes 13c. The vibration plate 13a is a metal member disposed on the upper surface of the channel unit 12 so as to cover a plurality of pressure chambers 12p. The piezoelectric layer 13b is disposed on the upper surface of the vibration plate 13a. The plurality of individual electrodes 13c is disposed on the upper surface of the piezoelectric layer 13b. Each of the plurality of individual electrodes 13c faces a corresponding one of the plurality of pressure chambers 12p.

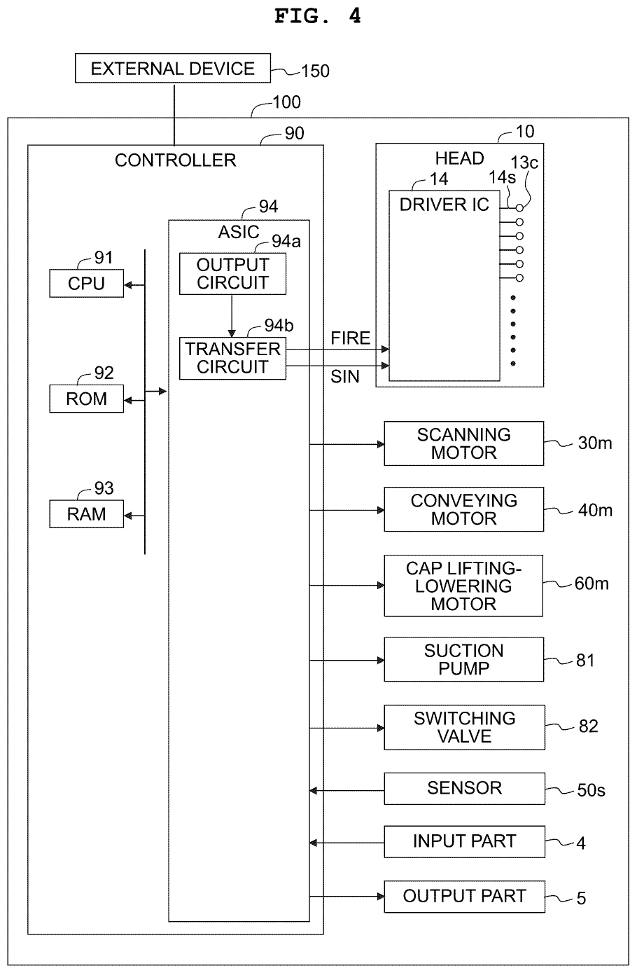

The vibration plate 13a and the plurality of individual electrodes 13c are electrically connected to a driver IC 14. The driver IC 14 changes the potential of each of the plurality of individual electrodes 13c between the ground potential and a driving potential, while maintaining the potential of the vibration plate 13a at the ground potential. Specifically, the driver IC 14 generates a driving signal based on a waveform signal FIRE and a selection signal SIN received from the controller 90 (see FIG. 4), and supplies the driving signal to each of the plurality of individual electrodes 13C via a corresponding signal line 14s. With this, the potential of each of the individual electrode 13c changes between the driving potential and the ground potential. In this situation, an actuator 13x including a part of the vibration plate 13a and a part of the piezoelectric layer 13b which are interposed between the individual electrode 13c and the pressure chamber 12p is deformed to thereby change the volume of the pressure chamber 12p. As a result, pressure is applied to the ink in the pressure chamber 12p, and ink is ejected from the nozzle 12n. The actuator 13x is disposed for each individual electrode 13c, that is, for each nozzle 12n. The actuator 13x is independently deformable in accordance with the potential supplied to the corresponding individual electrode 13c. The actuator 13x applies, to the ink in the individual channel 12b of the head 10, energy for ejecting the ink from the nozzle 12n, in accordance with the driving signal.

As depicted in FIG. 1 and FIG. 3, the scanning mechanism 30 includes two guide members 31 and 32 extending in the X direction and a scanning motor 30m (see FIG. 4). In response to the scanning motor 30m being driven under the control of the controller 90, the carriage 19 and the head 10 move in the X direction along the guide members 31 and 32.

The printer 100 further includes, in the casing 100a, a conveying mechanism 40 which conveys a sheet S in the Y direction, as depicted in FIG. 3.

The conveying mechanism 40 includes two roller pairs 41 and 42 and a conveying motor 40m (see FIG. 4). The head 10 and the carriage 19 are disposed between the roller pair 41 and the roller pair 42 in the Y direction. In response to the conveying motor 40m being driven under the control of the controller 90, the roller pair 41 and the roller pair 42 rotate in a state that the roller pair 41 and the roller pair 42 each hold the sheet S, and the sheet S is conveyed in the Y direction.

The cap 60 is disposed in an outside of a conveying area of the sheet S in which the sheet S is conveyed by the conveying mechanism 40, and at one end in the X direction of a movable area of the head 10 in which the head 10 is moved by the scanning mechanism 30, as depicted in FIG. 3.

The cap 60 has recessed parts 61. The recessed parts 61 include a recessed part 61C which receives the cyan ink discharged from the nozzles 12nC, a recessed part 61M which receives the magenta ink discharged from the nozzles 12nM, a recessed part 61Y which receives the yellow ink discharged from the nozzles 12nY, a recessed part 61K which receives the black ink discharged from the nozzles 12nK. The recessed parts 61 are each an example of a “receiver” of the present disclosure. In a case where the head 10 is located above the cap 60, the recessed part 61C overlaps with the nozzles 12nC in the Z direction, the recessed part 61M overlaps with the nozzles 12nM in the Z direction, the recessed part 61Y overlaps with the nozzles 12nY in the Z direction, and the recessed part 61K overlaps with the nozzles 12nK in the Z direction. In a case where the cyan ink is an example of the “first liquid” of the present disclosure and the magenta ink is an example of the “second liquid” of the present disclosure, the recessed part 61C is an example of a “first receiver” of the present disclosure and the recessed part 61M is an example of a “second receiver”of the present disclosure.

The cap 60 is movable in the Z direction by the driving of a cap lifting-lowering motor 60m (see FIG. 4). The cap lifting-lowering motor 60m is driven under the control of the controller 90, causing the cap 60 to move upward. When the head 10 is positioned above the cap 60, the cap 60 is moved upward into contact with the lower surface 12x of the channel unit 12 of the head 10. In this situation, an enclosed space is defined between the cap 60 and the head 10, and the cap 60 covers all of the plurality of nozzles 12n of the head 10. This state is referred to as a capping state. On the other hand, a state that the cap 60 is separated from the head 10 and does not cover the plurality of nozzles 12n, i.e., a state that the enclosed space is not defined between the cap 60 and the head 10 is referred to as an uncapping state.

Next, the configuration of a channel connecting the head 10, the cap 60, the ink cartridge 50, and the waste ink tank 70 to one another will be described, with reference to FIG. 1.

The head 10 and the ink cartridge 50 are connected to each other via tubes 21. The tubes 21 include a tube 21C connecting the buffer unit 11C and the ink cartridge 50C, a tube 21M connecting the buffer unit 11M and the ink cartridge 50M, a tube 21Y connecting the buffer unit 11Y and the ink cartridge 50Y, and a tube 21K connecting the buffer unit 11K and the ink cartridge 50K.

The recessed parts 61 of the cap 60 are connected to the ink cartridges 50 via tubes 22 and 23, and connected to the waste ink tank 70 via the tubes 22 and 24.

The tubes 22 include a tube 22C connected to the recessed part 61C, a tube 22M connected to the recessed part 61M, a tube 22Y connected to the recessed part 61Y, and a tube 22K connected to the recessed part 61K. Each tube 22 has one end connected to a corresponding recessed part 61 and the other end connected to a corresponding switching valve 82. Suction pumps 81 are each disposed at a position along a corresponding tube 22, between the one end and the other end of the tube 22.

The suction pumps 81 include a suction pump 81C disposed along the tube 22C, a suction pump 81M disposed along the tube 22M, a suction pump 81Y disposed along the tube 22Y, and a suction pump 81K disposed along the tube 22K.

The switching valves 82 include a switching valve 82C disposed at the other end of the tube 22C, a switching valve 82M disposed at the other end of the tube 22M, a switching valve 82Y disposed at the other end of the tube 22Y, and a switching valve 82K disposed at the other end of the tube 22K.

The tubes 23 each have one end connected to a corresponding switching valve 82 and the other end connected to a corresponding ink cartridge 50. The tubes 23 include a tube 23C connecting the switching valve 82C and the ink cartridge 50C, a tube 23M connecting the switching valve 82M and the ink cartridge 50M, a tube 23Y connecting the switching valve 82Y and the ink cartridge 50Y, and a tube 23K connecting the switching valve 82K and the ink cartridge 50K.

Regarding the tube 24, four parts each extending from a corresponding one of the switching valves 82C, 82M, 82Y, and 82K are joined into one part, and the one part is connected to the waste ink tank 70. In other words, the tube 24 has four one ends each of which is connected to the corresponding one of the switching valves 82C, 82M, 82Y, and 82K, and the other end which is single and which is connected to the waste ink tank 70.

The tubes 22, 23, and 21 form channels connecting the recessed parts 61 of the cap 60 and the buffer unit 11 of the head 10. The channels are each an example of a “recovery channel” of the present disclosure. In a case where the cyan ink is an example of the “first liquid” of the present disclosure and the magenta ink is an example of the “second liquid” of the present disclosure, the combination of the tubes 22C, 23C, and 21C is an example of a “first recovery channel” of the present disclosure, and the combination of the tubes 22M, 23M and 21M is an example of a “second recovery channel” of the present disclosure. The ink cartridge 50 is disposed in the recovery channel and constitutes a part of the recovery channel.

The tubes 22 and 24 form channels connecting the recessed parts 61 of the cap 60 and the waste ink tank 70. The channels are each an example of a “drain channel” of the present disclosure.

The switching valve 82 is selectively switchable between a recovery position and a drain position, under the control of the controller 90. The recovery position is a position of the switching valve 82 at which the switch valve 82 causes the tube 22 and the tube 23 to communicate with each other. The drain position is a position of the switching valve 82 at which the switching valve 82 causes the tube 22 and the tube 24 to communicate with each other. In such a manner, the switching valve 82 is switchable to either the recovery channel or the drain channel, as a channel through which ink flows from the recessed part 61 of the cap 60.

In the capping state, in a case where the suction pump 81 is driven under the control of the controller 90, the enclosed space between the cap 60 and the head 10 is depressurized. As a result, ink is forcibly discharged from the nozzles 12n. Discharging the ink forcibly from the nozzles 12n in such a manner is referred to as “purging”. The ink discharged by the purging is received by the recessed part 61 of the cap 60. In a state that the switching valve 82 is switched to the recovery position and the recovery channel is selected, the ink received by the recessed part 61 is fed to the buffer unit 11 of the head 10 via the tube 22, the tube 23, the ink cartridge 50, and the tube 21. On the other hand, in a state that the switching valve 82 is switched to the drain position and the drain channel is selected, the ink received by the recessed part 61 is fed to the waste ink tank 70 via the tube 22 and the tube 24.

The controller 90 is capable of performing a “purging process” of causing the head 10 to discharge the ink from the nozzles 12n to the recessed part 61. Further, the controller 90 selectively performs a “recovering process” and a “draining process”. In the “recovering process”, the controller 90 causes the switching valve 82 to switch to the recovery position, thereby feeding the ink from the recessed part 61 to the buffer unit 11 of the head 10 via the recovery channel. In the “draining process”, the controller 90 causes the switching valve 82 to switch to the drain position, thereby feeding the ink from the recessed part 61 to the waste ink tank 70 via the drain channel.

Next, the configuration of the controller 90 will be described with reference to FIG. 4.

The controller 90 includes a CPU 91, a ROM 92, a RAM 93, and an ASIC 94. Among the CPU 91, the ROM 92, the RAM 93, and the ASIC 94, the combination of the CPU 91 and the ASIC 94 is an example of a “controller” of the present disclosure; the RAM 93 is an example of a “memory”of the present disclosure.

The ROM 92 stores a program and data with which the CPU 91 and the ASIC 94 perform various control operations. The RAM 93 temporarily stores data to be used by each of the CPU 91 and the ASIC 94 so as to execute a program. The controller 90 is connected to an external device 150 such that the controller 90 and the external device 150 can communicate with each other. The external device 150 is, for example, a PC.

The CPU 91 executes various programs and performs processes, via ASIC 94, based on the data received from the external device 150 or an input part 4 of the printer 100. The input part 4 is, for example, a mouse or a keyboard. The above-described processes include a recording process of recording an image on the sheet S by causing the head 10 to eject the inks from the nozzles 12n to the sheet S, based on recording data received, for example, from the external device 150.

In the recording process, the ASIC 94 drives the driver IC 14, the scanning motor 30m and the conveying motor 40m based on the recording data received, for example, from the external device 150, in accordance with a command of the CPU 91, and alternately causes the conveying mechanism 40 to perform a conveying operation and causes the scanning mechanism 30 and the head 10 to perform a scanning operation. The conveying operation is an operation of conveying a sheet S by a predetermined amount in the Y direction using the conveying mechanism 40. The scanning operation is an operation of ejecting ink from the nozzles 12n of the head 10 based on a signal output from the driver IC 14 while moving the head 10 in the X direction using the scanning mechanism 30. The Y direction is an example of a “first direction” of the present disclosure, and the X direction is an example of a “second direction” of the present disclosure. In the scanning operation, the operation of moving the head 10 in the X direction using the scanning mechanism 30 is an operation of moving the head 10 and the sheet S relative to each other, and is an example of a “moving operation” of the present disclosure. The scanning mechanism 30 is an example of a “mover” of the present disclosure, as well as a “scanner” of the present disclosure. The conveying operation and the scanning operation are alternately performed to thereby form dots of the inks on the sheet S to record an image.

The ASIC 94 includes an output circuit 94a and a transfer circuit 94b.

The output circuit 94a generates the waveform signal FIRE and the selection signal SIN and outputs the waveform signal FIRE and the selection signal SIN to the transfer circuit 94b for each recording cycle. The recording cycle is a time required for the sheet S to move relative to the head 10 by a unit distance corresponding to the resolution of the image to be recorded on the sheet S. The recording cycle is the time since one ink droplet is ejected and until next ink droplet is ejected while ink droplets are continuously ejected from the nozzle 12n.

The waveform signal FIRE is a serial signal including four kinds of waveform data in series. The four kinds of waveform data correspond, respectively, to “zero”, “small”, “medium”, and “large” volumes of an ink droplet to be ejected from the nozzle 12n in one recording cycle. The phrase that the volume of the ink droplet is “zero” means that the ink droplet is not ejected from the nozzle 12n.

The selection signal SIN is a serial signal including data for selecting one of the above-described four kinds of waveform data. The selection signal SIN is generated for each of the plurality of actuators 13x and for each recording cycle based on the recording data.

The transfer circuit 94b transfers the waveform signal FIRE and the selection signal SIN received from the output circuit 94a to the driver IC 14. The transfer circuit 94b incorporates a plurality of LVDS drivers. The plurality of LVDS drivers includes an LVDS driver which transfers the waveform signal FIRE to the driver IC 14 as a pulsed differential signal, and an LVDS driver which transfers the selection signal SIN to the driver IC 14 as a pulsed differential signal.

The ASIC 94 controls the driver IC 14 in the recording process. The driver IC 14 generates the driving signals based on the waveform signal FIRE and the selection signal SIN. The driver IC 14 supplies the generated driving signals to the plurality of individual electrodes 13c via the signal lines 14s.

The driving signals include a driving signal for not causing the head 10 to eject the ink droplet from the nozzle 12n, a driving signal for causing the head 10 to eject a “small” ink droplet from the nozzle 12n, a driving signal for causing the head 10 to eject a “medium” ink droplet from the nozzle 12n, and a driving signal for causing the head 10 to eject a “large” ink droplet from the nozzle 12n. For example, the driving signal for causing the head 10 to eject the “small” ink droplet from the nozzle 12n is an example of a “first driving signal” of the present disclosure, and the driving signal for causing the head 10 to eject the “medium” ink droplet from the nozzle 12n is an example of a “second driving signal”of the present disclosure. Alternatively, the driving signal for causing the head 10 to eject the “medium” ink droplet from the nozzle 12n is an example of the “first driving signal” of the present disclosure, and the driving signal for causing the head 10 to eject the “large” ink droplet from the nozzle 12n is an example of the “second driving signal”of the present disclosure.

The driving potential of the second driving signal is greater than the driving potential of the first driving signal. The driving potential of the first driving signal is a first voltage V1 and the driving potential of the second driving signal is a second voltage V2 greater than the first voltage (V2>V1). The second driving signal may have a longer pulse width per recording cycle than the pulse width per recording cycle of the first driving signal. The second driving signal may have the number of pulses per recording cycle greater than the number of pulses per recording cycle of the first driving signal.

In the recording process, the ASIC 94 causes the driver IC 14 to selectively supply one of the above-described four kinds of driving signals to each of the plurality of individual electrodes 13c. As a result, an ink droplet with a volume, selected from the four kinds of volumes which are zero, small, medium and large, is ejected from each of the plurality of nozzles 12n.

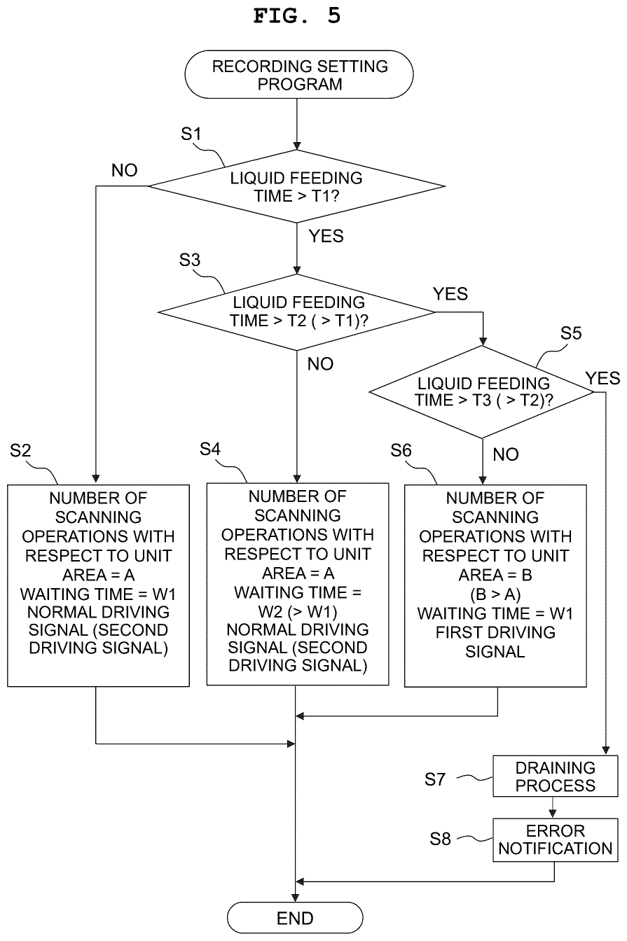

Next, a sequence of steps for a recording setting program executed by the CPU 91 will be described with reference to FIG. 5.

The recording setting program will be executed before performing the recording process. For example, the recording setting program may be executed periodically in a period in which the printer 100 is powered on.

In the recording setting program, the CPU 91 first determines whether a liquid feeding time exceeds a first liquid feeding time T1 (step S1: first determining process). The liquid feeding time is the time required to feed the ink of a predetermined amount to the common channel 12a and the plurality of individual channels 12b, which are the ink channel in the head 10, via the recovery channel.

For example, the CPU 91 may determine that the liquid feeding time exceeds the first liquid feeding time T1 (step S1: YES) in a case where a condition (1), that is a purge amount exceeds a predetermined amount, a condition (2), that is the number of times the purging process has been performed exceeds a predetermined number of times, or both of the above-described condition (1) and condition (2) are satisfied. The purge amount is an amount of ink discharged from the nozzles 12n in the purging process, and is obtained by multiplying the amount of ink discharged per purging process by the number of times the purging process has been performed. In a case where the condition (1) or the condition (2) is satisfied, the total amount of ink flowing in the circulation circuit from the head 10 and returning back to the head 10 via the cap 60 and the recovery channel, i.e., the circulation amount of ink, is large, and the composition of the ink is highly likely to have changed. In other words, the ink in the case where the condition (1) or the condition (2) is satisfied is highly likely to have higher viscosity or higher content amount of foreign matter in the ink compared to new ink. Further, in a configuration where a filter (not depicted in the drawings) is disposed in the recovery channel, the amount of foreign matter accumulated on the filter is highly likely to have reached a predetermined amount or more, in the case where the condition (1) or the condition (2) is satisfied. Due to the change in the composition of the ink or the amount of foreign matter accumulated on the filter, the ink might not flow smoothly in the recovery channel, leading to an increase in the liquid feeding time.

In a case where a condition (3), that is the number of recorded pages or an ink usage amount exceeds a threshold value, is satisfied, the CPU 91 may determine that the liquid feeding time exceeds the first liquid feeding time T1 (step S1: YES). The number of recorded pages is the number of sheets S on which the recording has been performed in the recording process. The ink usage amount is an amount of ink used in the recording process, and is calculated by multiplying the volume of one ink droplet ejected from the nozzle 12n by the number of ink droplets. In a case where the condition (3) is satisfied under a condition that the number of recorded pages and the ink usage amount are proportional to the circulation amount, the circulation amount is large. Therefore, as in the case where the condition (1) or the condition (2) is satisfied, the composition of the ink is highly likely to have changed or the amount of foreign matter accumulated on the filter is highly likely to have reached the predetermined amount or more. Accordingly, the ink might not flow smoothly in the recovery channel, leading to an increase in liquid feeding time.

In a case where a condition (4), that is a duration in which the recording process is not performed exceeds a predetermined time, is satisfied; a condition (5), that is the number of recorded pages per unit time or the ink usage amount per unit time is less than a threshold value, is satisfied; or both the condition (4) and the condition (5) are satisfied, the CPU 91 may determine that the liquid feeding time exceeds the first liquid feeding time T1 (step S1: YES). In a case where the condition (4) or the condition (5) is satisfied, due to stagnation of the flow of the ink inside the head 10, the viscosity of the ink is highly likely to have been increased or the foreign matter in the ink is highly likely to have been sedimented. In such a case, the ink might not flow smoothly also in the recovery channel communicating with the head 10, leading to an increase in liquid feeding time. Each of the condition (1) to the condition (5) used in the step S1 is an example of “a first condition”of the present disclosure.

In a case where the CPU 91 determines that the liquid feeding time does not exceed the first liquid feeding time T1 (step S1: NO), the CPU 91 performs a setting (step S2) described below. That is, the CPU 91 sets the number of scanning operations per unit area of the sheet S to “A”, where “A” is a natural number greater than or equal to 1. Then, the CPU 91 causes the RAM 93 to store setting information of the setting. The CPU 91 causes the scanning mechanism 30 to perform, based on the stored setting information, the scanning operation “A” times with respect to the unit area of the sheet S in a period between the Nth conveying operation (where “N” is a natural number greater than or equal to 1) and the (N+1)th conveying operation in the recording process. The unit area is a partial area of the sheet S, and is a rectangular area extending in the X direction within the movable area of the head 10 in which the head 10 is moved by the scanning mechanism 30. Further, the CPU 91 sets a waiting time to a first waiting time W1. The CPU 91 causes the RAM 93 to store setting information of the setting. The CPU 91 causes, based on the stored setting information, the scanning mechanism 30 to start the (M+1)th scanning operation (where M is a natural number greater than or equal to 1) after a first waiting time W1 elapses since a time at which the Mth scanning operation is completed in the recording process. Note that the number of the scanning operation (that is, M) is the number counted over the plurality of unit areas. Furthermore, the CPU 91 performs a setting to use the second driving signal in the recording process, and the CPU 91 causes the RAM 93 to store setting information of the setting (step S2). The second driving signal is a driving signal for causing the head 10 to eject an ink droplet of a standard volume, which is predetermined based on the recording data, from the nozzle 12n.

In a case where the CPU 91 determines that the liquid feeding time exceeds the first liquid feeding time T1 (step S1: YES), the CPU 91 determines whether the liquid feeding time exceeds a second liquid feeding time T2 (step S3: second determining process). The second liquid feeding time T2 is longer than the first liquid feeding time T1 (T2>T1).

For example, in the step S3, in a case where any of the condition (1) to the condition (5) as described above is satisfied, the CPU 91 may determine that the liquid feeding time exceeds the second liquid feeding time T2 (step S3: YES). Note that, in the step S3, the thresholds of the condition (1) to the condition (5) are different from the thresholds of the condition (1) to the condition (5) used in the step S1, respectively. Specifically, “the predetermined amount” in the condition (1) used in the step S3 is greater than “the predetermined amount” in the condition (1) used in the step S1. “The predetermined number of times” in the condition (2) used in the step S3 is greater than “the predetermined number of times” in the condition (2) used in the step S1. “The threshold value” in the condition (3) used in the step S3 is greater than “the threshold value” in the condition (3) used in the step S1. “The predetermined time” in the condition (4) used in the step S3 is greater than “the predetermined time” in the condition (4) used in the step S1. “The threshold value” in the condition (5) used in the step S3 is smaller than “the threshold value” in the condition (5) used in the step S1. Each of the condition (1) to the condition (5) used in the step S3 is an example of “a second condition” of the present disclosure.

In a case where the CPU 91 determines that the liquid feeding time does not exceed the second liquid feeding time T2 (step S3: NO), the CPU 91 sets the number of scanning operations per unit area to “A”. Then, the CPU 91 causes the RAM 93 to store setting information of the setting. The CPU 91 causes the scanning mechanism 30 to perform the scanning operation A times with respect to a unit area of the sheet S in a period between the Nth conveying operation and the (N+1)th conveying operation in the recording process (step S4). Further, the CPU 91 sets a waiting time to a second waiting time W2. The second waiting time W2 is longer than the first waiting time W1. The CPU 91 causes the RAM 93 to store setting information of the setting (step S4). The CPU 91 causes the scanning mechanism 30 to start the (M+1)th scanning operation after the second waiting time W2 elapses since the time at which the Mth scanning operation is completed in the recording process. Furthermore, the CPU 91 performs a setting to use the second driving signal in the recording process, and the CPU 91 causes the RAM 93 to store setting information of the setting (step S4).

In a case where the CPU 91 determines that the liquid feeding time exceeds the second liquid feeding time T2 (step S3: YES), the CPU 91 determines whether the liquid feeding time exceeds a third liquid feeding time T3 (step S5: third determining process). The third liquid feeding time T3 is longer than the second liquid feeding time T2 (T3>T2).

For example, in the step S5, in a case where any of the condition (1) to the condition (5) as described above is satisfied, the CPU 91 may determine that the liquid feeding time exceeds the third liquid feeding time T3 (step S5: YES). Note that, in the step S5, the thresholds of the condition (1) to the condition (5) are different from the thresholds of the condition (1) to the condition (5) used in the step S3, respectively. Specifically, “the predetermined amount” in the condition (1) used in the step S5 is greater than “the predetermined amount” in the condition (1) used in the step S3. “The predetermined number of times” in the condition (2) used in the step S5 is greater than “the predetermined number of times” in the condition (2) used in the step S3. “The threshold value” in the condition (3) used in the step S5 is greater than “the threshold value” in the condition (3) used in the step S3. “The predetermined time” in the condition (4) used in the step S5 is greater than “the predetermined time” in the condition (4) used in the step S3. “The threshold value” in the condition (5) used in the step S5 is smaller than “the threshold value” in the condition (5) used in the step S3. Each of the condition (1) to the condition (5) used in the step S5 is an example of “a third condition”of the present disclosure.

In a case where the CPU 91 determines that the liquid feeding time does not exceed the third liquid feeding time T3 (step S5: NO), the CPU 91 sets the number of scanning operations per unit area of the sheet S to “B”, where “B” is a natural number greater than “A”. Then, the CPU 91 causes the RAM 93 to store setting information of the setting (step S6). The CPU 91 causes the scanning mechanism 30 to perform the scanning operation B times with respect to a unit area of the sheet S in a period between the Nth conveying operation and the (N+1)th conveying operation in the recording process. Further, the CPU 91 sets a waiting time to a first waiting time W1. The CPU 91 causes the RAM 93 to store setting information of the setting (step S6). The CPU 91 causes the scanning mechanism 30 to start the (M+1)th scanning operation after the first waiting time W1 elapses since the time at which the Mth scanning operation is completed in the recording process. Furthermore, the CPU 91 performs a setting to use the first driving signal in the recording process, and the CPU 91 causes the RAM 93 to store setting information of the setting (step S6). The first driving signal is a driving signal for causing the head 10 to eject the ink droplet of the smaller volume than the volume of the ink droplet ejected by the second driving signal.

In a case where the CPU 91 determines that the liquid feeding time exceeds the third liquid feeding time T3 (step S5: YES), the CPU 91 causes the printer 100 to perform the draining process (step S7).

In the draining process, the CPU 91 causes the switching valves 82 to switch to the discharge position, and drives the suction pump 81. With this, the ink discharged from the nozzles 12n and received by the recessed part 61 is fed to the waste ink tank 70 via the tube 22 and the tube 24.

After the step S7, the CPU 91 performs error notification via an output part 5 (see FIG. 4) (step S8). The error notification is, for example, a notification urging a user to replace the ink cartridge 50. The output part 5 includes, for example, a display or a speaker.

After the step S2, the step S4, the step S6 or the step S8, the CPU 91 ends the recording setting program.

In the recording process after the recording setting program has been ended, the CPU 91 controls operations of each of the driver IC 14, the scanning motor 30m, and the conveying motor 40m, based on the information set in the recording setting program.

For example, in a case where the CPU 91 sets the number of scanning operations to “A” (in this embodiment, A may be “1”) in the step S2 or the step S4, then in the recording process, the CPU 91 drives the scanning motor 30m and the driver IC 14 so as to cause the scanning mechanism 30 and the head 10 to perform the scanning operation one time in a period between the Nth conveying operation and the (N+1)th conveying operation, in a state that the conveying motor 40m is stopped. In the scanning operation performed one time, the head 10 ejects the ink droplets from the plurality of nozzles 12n in accordance with the second driving signals while moving from one side toward the other side in the X direction. In such a manner, the scanning operation is performed one time with respect to the unit area of the sheet S.

For example, in a case where the CPU 91 sets the number of scanning operations to “B” (in this embodiment, B may be “2”) in the step S6, the CPU 91 drives the scanning motor 30m and the driver IC 14 so as to cause the scanning mechanism 30 and the head 10 to perform the scanning operation two times in a period between the Nth conveying operation and the (N+1)th conveying operation, in the state that the conveying motor 40m is stopped. In the scanning operation performed first among the scanning operation of two times, the head 10 ejects the ink droplets from the plurality of nozzles 12n in accordance with the first driving signals while moving from one side toward the other side in the X direction. In the scanning operation performed second among the scanning operation of two times, the head 10 ejects the ink droplets from the plurality of nozzles 12n in accordance with the first driving signals while moving from the other side toward the one side in the X direction. In such a manner, the scanning operation is performed two times with respect to the unit area of the sheet S.

In the recording process after the setting information of the step S2 or the step S6 has been stored in the RAM 93, the CPU 91 controls the scanning motor 30m to start the next scanning operation after the first waiting time W1 elapses since a time at which each scanning operation is completed.

In the recording process after the setting information of the step S4 has been stored in the RAM 93, the CPU 91 controls the scanning motor 30m to start the next scanning operation after the second waiting time W2 (W2>W1) elapses since a time at which each scanning operation is completed.

Performing the recording process in a state that the waiting time is set to the second waiting time W2 (W2>W1) in the step S4 is an example of “first control” of the present disclosure. The longer the waiting time is, the longer the recording time with respect to the unit area of the sheet S is.

Performing the recording process in a state that the number of scanning operations with respect to the unit area of the sheet S is set to “B” greater than “A” (B>A) in the step S6 is an example of the “first control” of the present disclosure. The more the number of scanning operations performed with respect to the unit area of sheet S is, the longer the recording time with respect to the unit area of sheet S is.

Performing the recording process in a state that supplying of the first drive signal is set in the step S6 is an example of “second control” of the present disclosure. The smaller the volume of the ink droplet to be ejected from the nozzle 12n is, the smaller the ejection amount of the ink with respect to the unit area of the sheet S is.

Note that the CPU 91 executes the recording setting program with respect to the ink of each color. Specifically, the RAM 93 stores information which serves as a determination criterion in each of the step S1, the step S3, and the step S5 with respect to the ink of each color. The information which serves as the determination criterion in each of the step S1, the step S3, and the step S5 is a value to be compared with the threshold of at least one of the condition (1) to condition (5), for example, the purge amount, the number of times the purging process has been performed, the ink usage amount (an example of “first information” and “second information” of the present disclosure). The CPU 91 performs the determination in the step S1, the step S3, the step S5, etc., with respect to the ink of each color, based on the information stored in the RAM 93, and the CPU 91 causes the RAM 93 to store the setting information regarding the recording process (step S2, step S4, or step S6). In the recording process, the CPU 91 performs the control based on the setting information which is included in the above-described multiple setting information and which regards the ink of the color to be used in the recording process, i.e., the ink of the color to be ejected onto the sheet S.

For example, in a case where the black ink is solely to be used in the recording process, the CPU 91 may perform the control based on the setting information regarding the black ink. The setting information regarding the black ink is the setting information of the step S2, the step S4, or the step S6 set based on the information regarding the black ink in the recording setting program.

For example, in a case where the cyan ink, the magenta ink, the yellow ink, and the black ink are to be used in the recording process, the CPU 91 may perform control based on one of the multiple setting information regarding the inks of four colors. The multiple setting information regarding the inks of four colors includes the setting information which is set in the recording setting program based on each of the information regarding one of the inks of four colors in the step S2, the step S4, or the step S6. In a case where the recording setting programs executed based on the multiple information regarding the inks of four colors include the recording setting program in which the information of the step S6 is set, the CPU 91 may perform the control based on the setting information set in the step S6. In a case where the recording setting programs executed based on the multiple information regarding the inks of four colors do not include the recording setting program in which the information of the step S6 is set, but include the recording setting program in which the information of the step S4 is set, the CPU 91 may perform the control based on the setting information set in the step S4. In a case where the recording setting programs executed based on the multiple information regarding the inks of four colors do not include the recording setting program in which the information of the step S6 or S4 is set, but the information of the step S is set in all the recording setting programs, the CPU 91 may perform the control based on the setting information set in the step S2.

The recording setting program and the recording process is applicable also to a configuration wherein the head 10 includes the plurality of heads 10 each used for one of the four color inks, namely, the cyan ink, the magenta ink, the yellow ink and the black ink. In this configuration, in a case where the ink of each of the four colors is used in the recording process, the CPU 91 may perform the control of a certain head 10 based on the setting information set in the step S2, the step S4 or the step S6 of the recording setting program with respect to the certain head 10. In this case, the waiting time or the number of times the scanning operation is to be performed with respect to the unit area of sheet S may be different among the plurality of heads 10.

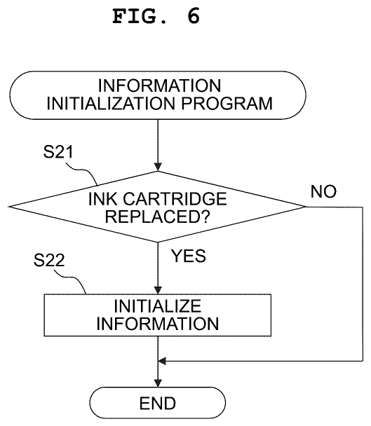

Next, an information initializing program executed by the CPU 91 will be described, with reference to FIG. 6.

The information initializing program may be executed repeatedly in a period in which the printer 100 is powered on.

In the information initializing program, the CPU 91 first determines, based on a signal from a sensor 50s (see FIG. 4) disposed in the accommodating part 50v, whether the ink cartridge 50 in the accommodating part 50v has been replaced (step S21: fourth determining process). The sensor 50s outputs an ON signal in a case where the ink cartridge 50 is present in the accommodating part 50v and an OFF signal in a case where the ink cartridge 50 is absent from the accommodating part 50v.

In a case where the CPU 91 determines that the ink cartridge 50 in the accommodating part 50v has been replaced (step S21: YES), the CPU 91 initializes the information which serves as the determination criterion in each of the step S1, the step S3, and the step S5 (step S22: initializing step). The information which serves as the determination criterion in each of the step S1, the step S3, and the step S5 is, for example, the purge amount, the number of times the purging process has been performed and the ink usage amount (an example of the “first information”and the “second information”of the present disclosure).

After the step S22, or in a case where the CPU 91 determines that the ink cartridge 50 in the accommodating part 50v has not been replaced (step S21: NO), the CPU 91 ends the information initializing program.

Note that in a case where the accommodating part 50v accommodates one ink cartridge 50 in which the four ink cartridges 50C, 50M, 50Y and 50K are integrated, the CPU 91 may initialize the information regarding inks of all colors in the step S22.

In a case where the accommodating part 50v accommodates the four ink cartridges 50C, 50M, 50Y and 50K individually, the CPU 91 may execute the information initializing program with respect to the ink of each color. In this case, in the step S21, the CPU 91 determines whether the ink cartridge 50 of the ink of a certain color has been replaced based on a signal from corresponding one of the sensors 50s (see FIG. 4) provided for the four ink cartridges 50C, 50M, 50Y and 50K, respectively. The CPU 91 may initialize the information regarding the ink of the certain color in the step S22.

As described above, according to the present embodiment, in a case where the liquid feeding time required to feed the predetermined amount of ink to the liquid channel via the recovery channel exceeds the first liquid feeding time T1 (step S1: YES), the CPU 91 (the printer 100) sets the waiting time to the second waiting time W2 (W2>W1) (step S4), or the CPU 91 sets the number of scanning operations with respect to the unit area of the sheet S to “B” (B>A) and performs the setting to supply, to the actuator 13x, the first driving signal for causing the actuator 13x to eject, from the nozzle 12n, the ink droplet of the smaller volume than the volume of the ink droplet ejected by the second driving signal (step S6). In a case where the CPU 91 sets the waiting time to the second waiting time W2 (W2>W1) in the step S4 or in a case where the CPU 91 sets the number of scanning operations with respect to the unit area of the sheet S to “B” (B>A) in the step S6, the recording time with respect to the unit area of the sheet S will be lengthen. In a case where the CPU 91 performs the setting to supply, to the actuator 13x, the first driving signal for ejecting the ink droplet of the smaller volume than the volume of the ink droplet ejected by the second driving signal in the step S6, the ejection amount of the ink with respect to the unit area of the sheet S will decrease. With this, even in a case where the liquid feeding time exceeds the first liquid feeding time T1, the ink can be supplied to the head 10 in time for the ejection, and thus the streaking, etc., does not occur in the image, and the deterioration of the image quality can be reduced. Namely, according to the present embodiment, the deterioration of the image quality can be reduced in the configuration wherein the ink ejected from the nozzles 12n is reused.

In a case where the CPU 91 determines that the liquid feeding time exceeds the first liquid feeding time T1 (step S1: YES) and proceeds the process to the step S4, the CPU 91 sets the waiting time to the second waiting time W2 (W2>W1) (step S4). In this case, the ink can be supplied to the head 10 during the second waiting time W2 which is relatively long, and the ink can be supplied to the head 10 in time for the ejection.

In a case where the CPU 91 determines that the liquid feeding time exceeds the first liquid feeding time T1 (step S1: YES) and proceeds the process to the step S6, the CPU 91 sets the number of scanning operations with respect to the unit area of the sheet S to “B” (B>A) (step S6). In this case, since the number of scanning operations with respect to the unit area of the sheet S is relatively great, the amount of the ink to be supplied to the head 10 in one scanning operation can be reduced. With this, the ink can be supplied to the head 10 in time for the ejection.

In a case where the CPU 91 determines that the liquid feeding time exceeds the first liquid feeding time T1 (step S1: YES) and proceeds the process to the step S6, the CPU 91 performs the setting to use the first driving signal for causing the head 10 to eject the ink droplet of the smaller volume than the volume of the ink droplet ejected by the second driving signal (step S6). In this case, since the volume of the ink droplet ejected from the nozzle 12n is relatively small, the ejection amount of the ink with respect to the unit area of the sheet S can be reduced. With this, the ink can be supplied to the head 10 in time for the ejection.

In a case where the CPU 91 determines that the liquid feeding time exceeds the second liquid feeding time T2 (step S3: YES), if the CPU 91 performs the control to lengthen the waiting time (step S4) so that the ink can be supplied to the head 10 in time for the ejection, the waiting time may be long and the recording may take time. Therefore, in the present embodiment, in a case where the CPU 91 determines that the liquid feeding time exceeds the second liquid feeding time T2 (step S3: YES), the CPU 91 performs the control to increase the number of scanning operations with respect to the unit area of the sheet S, rather than the control to lengthen the waiting time (step S4). With this, such a problem that the recording takes time which might occur due to a long waiting time can be avoided, and a high-speed recording can be realized. On the other hand, in a case where the CPU 91 determines that the liquid feeding time does not exceed the second liquid feeding time (step S3: NO), the control to lengthen the waiting time (step S4) takes less time for the recording than the control to increase the number of scanning operations with respect to the unit area of the sheet S (step S6), and thus the high-seed recording can be realized. Therefore, in the present embodiment, the CPU 91 performs the control of the step S4 in such a case.

In a case where the CPU 91 determines that the liquid feeding time exceeds the second liquid feeding time T2 (step S3: YES), if the CPU 91 performs the control to lengthen the waiting time (step S4) so that the ink can be supplied to the head 10 in time for the ejection, the waiting time may be long and the recording may take time. In this regard, in the present embodiment, in a case where the CPU 91 determines that the liquid feeding time exceeds the second liquid feeding time T2 (step S3: YES), the CPU 91 performs the control to use the first driving signal (step S6), rather than performing the control to lengthen the waiting time (step S4). With this, such a problem that the recording takes time which might occur due to a long waiting time can be avoided, and the high-speed recording can be realized. On the other hand, in a case where the CPU 91 determines that the liquid feeding time does not exceed the second liquid feeding time T2 (step S3: NO), even if the CPU 91 performs the control to lengthen the waiting time (step S4), the recording does not take much time. Accordingly, in the present embodiment, the CPU 91 performs the step S4.

In a case where the CPU 91 determines that the liquid feeding time exceeds the third liquid feeding time T3 (step S5: YES), the CPU 91 performs the draining process (step S7), and the ink is drained from the recessed part 61 into the waste ink tank 70. With this, such a situation that the ink with a changed composition flows from the recessed part 61 to the head 10 can be avoided, and the deterioration of the recording quality during the recording process can be reduced.

In a case where the CPU 91 determines that the ink cartridge 50 has been replaced (step S21: YES), the following presumption holds. That is, a new ink cartridge 50, i.e., an ink cartridge 50 storing fresh ink, is accommodated in the accommodating part 50v and that the fresh ink is supplied to the head 10 via the recovery channel. Therefore, in this case, the CPU 91 initializes the information for determining whether the liquid feeding time exceeds the liquid feeding time T1, T2 or T3 (step S22). With this, the CPU 91 can appropriately perform the determination in each of the step S1, the step S3, and the step S5.

The CPU 91 determines that the liquid feeding time exceeds the liquid feeding time T1, T2 or T3 in a case where the CPU 91 determines that the condition (1), that is the purge amount, i.e., the amount of the ink discharged in the purging process, exceeds the predetermined amount, is satisfied, the condition (2), that is the number of times the purging process has been performed exceeds the predetermined number of times, is satisfied, or both the condition (1) and the condition (2) are satisfied. In this case, the CPU 91 can appropriately perform the determination in each of the step S1, the step S3, and the step S5.

The information serving as the determination criterion in each of the step S1, the step S3, and the step S5, i.e., the purge amount, the number of times the purging process has been performed, the ink usage amount, etc., are stored in the RAM 93 with respect to the ink of each color. In the recording process, the CPU 91 performs the control corresponding to the recording setting program executed based on the information included in the above-described information and regarding the ink to be used in the recording process. With this, the CPU 91 is capable of performing reasonable control in accordance with the status of the ink to be used in the recording process.

### Modifications

While the invention has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the invention, and not limiting the invention. Various changes may be made without departing from the spirit and scope of the disclosure. Therefore, the disclosure is intended to embrace all known or later developed alternatives, modifications, variations, improvements, and/or substantial equivalents. Some specific examples of potential alternatives, modifications, or variations in the described invention are provided below:

Although the ink cartridge 50 is disposed in the recovery channel in the above-described embodiment, the ink cartridge 50 may not be disposed in the recovery channel.

In the above-described embodiment, in a case where the CPU 91 determines that the liquid feeding time exceeds the first liquid feeding time T1 (step S1: YES), and further determines that the liquid feeding time exceeds the second liquid feeding time T2 (step S3: YES) and does not exceed the third liquid feeding time T3 (step S5: NO), the CPU 91 sets the number of scanning operations with respect to the unit area of the sheet S to the “B” (B>A) in the step S6, and performs the setting to use the first driving signal in the recording process. In the recording process performed after the setting information of the step S6 has been stored in the RAM 93, the CPU 91 performs both the “first control” and the “second control”. The present disclosure, however, is not limited to this, and the CPU 91 may perform either one of the “first control”and the “second control”.

In the above-described embodiment, in a case where the CPU 91 determines that the liquid feeding time exceeds the first liquid feeding time T1 (step S1: YES), the CPU 91 performs the second determining process (step S3) of determining whether the liquid feeding time exceeds the second liquid feeding time T2. However, the step S3 may be omitted. In this case, in a case where the CPU 91 determines that the liquid feeding time exceeds the first liquid feeding time T1 (step S1: YES), the CPU 91 may proceed the process to the step S4 or the step S6.

In the above-described embodiment, in a case where the CPU 91 determines that the liquid feeding time exceeds the second liquid feeding time T2 (step S3: YES), the CPU 91 performs the third determining process (step S5) of determining whether the liquid feeding time exceeds the third liquid feeding time T3. However, the step S5 may be omitted. In this case, in a case where the CPU 91 determines that the liquid feeding time exceeds the second liquid feeding time T2 (step S3: YES), the CPU 91 may proceed the process to the step S6.

In the above-described embodiment, the scanning mechanism 30 is exemplified as the “mover” of the present disclosure, and the operation of moving the head 10 in the X direction by the scanning mechanism 30 is exemplified as the “moving operation” of the present disclosure. The present disclosure, however, is not limited to this. For example, the conveying mechanism 40 may be an example of the “mover” of the present disclosure, and the conveying operation may be an example of the “moving operation” of the present disclosure. Also in this case, in a case where the CPU 91 determines that the liquid feeding time exceeds the first liquid feeding time T1 (step S1: YES), the CPU 91 may set the waiting time between the Sth conveying operation and the (S+1)th conveying operation to the second waiting time W2 (W2>W1) (step S4). By doing so, the ink can be supplied to the head 10 during the second waiting time W2 which is relatively long, and the ink can be supplied to the head 10 in time for the ejection. In this modification, a unit area may be a combination of an area to which the printing is performed by a head after the Sth conveying operation and an area to which the printing is performed by the head after the (S+1)th conveying operation. In this modification, the head may be, for example, the head 10 moved by the scanning mechanism 30, any serial head like the head 10, or any line head of a printer of line head type. Each of the Sth conveying operation and the Mth scanning operation is an example of “the Xth moving operation” of the disclosure, and each of the (S+1)th conveying operation and the (M+1)th scanning operation is an example of “the (X+1)th moving operation”of the disclosure.

In the above-described embodiment, regarding supplying of the first driving signal to the actuator in the recording process, the CPU 91 performs the setting so as to use the first driving signal in the recording process and causes the RAM 93 to store the setting information in the step S6 of the recording setting program. The present disclosure, however, is not limited to this. For example, in the recording process, the CPU 91 may convert the received recording data in a direction in which the density value becomes smaller. In this case, the ejection amount of the ink with respect to the unit area of the sheet S is decreased in the recording process, and the ink can be supplied to the head 10 in time for the ejection.

The head of the above-described embodiment ejects the liquids of mutually different kinds, specifically, the inks of mutually different colors. The present disclosure, however, is not limited to this. For example, the head may solely eject liquid of the same kind, e.g., an ink of the same color.

The accommodating part 50v may accommodate an ink tank which is not generally detachable and attachable by the user with respect to the casing 100a, rather than accommodating the ink cartridge 50 as the ink tank which is detachable and attachable by the user with respect to the casing 100a.

The liquid ejected from the nozzles is not limited to being the ink, and can also be another liquid which is different from the ink, for example, such as treatment liquid which agglutinates or precipitates a component of the ink.

The actuator is not limited to being the actuator of the piezoelectric system using the piezoelectric element, but may also be, for example, an actuator of the thermal system using a heating element, and an actuator of the electrostatic system using an electrostatic force.

The recording medium is not limited to being the sheet, and may be, for example, cloth and a resin member, etc.

The present disclosure is not limited to being applicable to the printer, but is also applicable, for example, to a facsimile, a copy machine, and a multi-function peripheral. Further, the present disclosure is applicable also to a liquid ejecting apparatus used for any other application than the image recording, for example, a liquid ejecting apparatus which ejects electroconductive liquid onto a substrate so as to form an electroconductive pattern.

The program according to the present disclosure can be recorded and distributed on a removable storage medium such as a flexible disc or a fixed recording medium such as a hard disk, and can also be distributed via a communication line.

The first condition, the second condition, and the third condition may include any condition representing an increase of a liquid feeding time, in addition to or instead of at least one of the conditions (1) to (5).

What is claimed is

1. A liquid ejecting apparatus comprising:
a head having a liquid channel including a nozzle;
a receiver;
a recovery channel connecting the receiver and the liquid channel; and
a controller that causes the liquid ejecting apparatus to perform:
a recovering process of feeding liquid from the receiver to the liquid channel via the recovery channel;
a first determining process of determining whether a first condition is satisfied, the first condition representing a first increase of a liquid feeding time required to feed a predetermined amount of liquid to the liquid channel via the recovery channel; and
a recording process of recording an image on a recording medium by causing the head to eject liquid from the nozzle to the recording medium,
wherein, in response to determining in the first determining process that the first condition is satisfied, the controller causes the liquid ejecting apparatus to perform, in the recording process, at least one of:
a first control in which a recording time with respect to a unit area of the recording medium is longer than a recording time with respect to the unit area of a case where the controller determines in the first determining process that the first condition is not satisfied, or
a second control in which an ejection amount of liquid with respect to the unit area of the recording medium is less than an ejection amount of a case where the controller determines in the first determining process that the first condition is not satisfied.

2. The liquid ejecting apparatus according to claim 1, further comprising a mover, wherein:
in the recording process, the controller causes the mover to perform a plurality of moving operations, and causes the mover to start the (X+1)th moving operation (where X is a natural number greater than or equal to 1) after a waiting time elapses since a time at which the Xth moving operation is completed, each moving operation including moving the head relative to the recording medium or moving the recording medium relative to the head;
in response to determining in the first determining process that the first condition is not satisfied, the controller sets the waiting time to a first waiting time; and
in response to determining in the first determining process that the first condition is satisfied, the controller causes the liquid ejecting apparatus to perform, in the recording process, the first control in a state that the waiting time is set to a second waiting time longer than the first waiting time.

3. The liquid ejecting apparatus according to claim 1, further comprising:
a conveyor; and
a scanner, wherein:
the controller causes the conveyor to perform a conveying operation and causes the scanner to perform a scanning operation alternately in the recording process, the conveying operation including conveying the recording medium in a first direction, the scanning operation including moving the head in a second direction crossing the first direction;
in response to determining in the first determining process that the first condition is not satisfied, the controller causes, in the recording process, the scanner to perform the scanning operation A times (where A is a natural number greater than or equal to 1) in a period between the Nth conveying operation (where N is a natural number greater than or equal to1) and the (N+1)th conveying operation; and
in response to determining in the first determining process that the first condition is satisfied, the controller causes the scanner to perform the scanning operation B times (where B is a natural number greater than A) in the period between the Nth conveying operation and the (N+1)th conveying operation so as to perform the first control in the recording process.

4. The liquid ejecting apparatus according to claim 1, wherein:
the head includes an actuator;
the controller causes the head to eject liquid from the nozzle by selectively supplying a first driving signal or a second driving signal to the actuator in the recording process, the first driving signal being a signal for causing the actuator to eject a droplet of a first volume from the nozzle, the second driving signal being a signal for causing the actuator to eject a droplet of a second volume greater than the first volume from the nozzle;
in response to determining in the first determining process that the first condition is not satisfied, the controller causes the liquid ejecting apparatus to supply the second driving signal to the actuator in the recording process; and
in response to determining in the first determining process that the first condition is satisfied, the controller causes the liquid ejecting apparatus to supply the first driving signal to the actuator in the recording process.

5. The liquid ejecting apparatus according to claim 3, wherein:
the controller causes the scanner to start the (M+1)th scanning operation (where M is a natural number greater than or equal to 1) after a waiting time elapses since a time at which the Mth scanning operation is completed, in the recording process;
in response to determining in the first determining process that the first condition is not satisfied, the controller sets the waiting time to a first waiting time;
in response to determining in the first determining process that the first condition is satisfied, the controller causes the liquid ejecting apparatus to perform a second determining process of determining whether a second condition representing a second increase of the liquid feeding time is satisfied, the second increase being greater than the first increase;
in response to determining in the second determining process that the second condition is satisfied, the controller causes the scanner to perform the scanning operation B times in the period between the Nth conveying operation and the (N+1)th conveying operation; and
in response to determining in the second determining process that the second condition is not satisfied, the controller causes the liquid ejecting apparatus to perform, in the recording process, the first control in a state that the waiting time is set to a second waiting time longer than the first waiting time.

6. The liquid ejecting apparatus according to claim 4, further comprising a mover, wherein:
in the recording process, the controller causes the mover to perform a plurality of moving operations, and causes the mover to start the (X+1)th moving operation (where X is a natural number greater than or equal to 1) after a waiting time elapses since a time at which the Xth moving operation is completed, each moving operation including moving the head relative to the recording medium or moving the recording medium relative to the head;
in response to determining in the first determining process that the first condition is not satisfied, the controller sets the waiting time to a first waiting time;
in response to determining in the first determining process that the first condition is satisfied, the controller causes the liquid ejecting apparatus to perform a second determining process of determining whether a second condition representing a second increase of the liquid feeding time is satisfied, the second increase being greater than the first increase;
in response to determining in the second determining process that the second condition is satisfied, the controller causes the liquid ejecting apparatus to supply the first driving signal to the actuator so as to perform the second control in the recording process; and
in response to determining in the second determining process that the second condition is not satisfied, the controller causes the liquid ejecting apparatus to perform, in the recording process, the first control in a state that the waiting time is set to a second waiting time longer than the first waiting time.

7. The liquid ejecting apparatus according to claim 5, further comprising:
a waste liquid reservoir; and
a drain channel connecting the receiver and the waste liquid reservoir, wherein:
the controller causes the liquid ejecting apparatus to perform:
a draining process of feeding liquid from the receiver to the waste liquid reservoir via the drain channel; and
a third determining process of determining whether a third condition representing a third increase of the liquid feeding time is satisfied, in response to determining in the second determining process that the second condition is satisfied, the third increase being greater than the second increase; and
in response to determining in the third determining process that the third condition is satisfied, the controller causes the liquid ejecting apparatus to perform the draining process.

8. The liquid ejecting apparatus according to claim 1, further comprising a holder, wherein:
the controller causes the liquid ejecting apparatus to perform:
a fourth determining process of determining whether a liquid reservoir in the holder has been replaced; and
an initializing process of initializing information for determining whether the first condition is satisfied in the first determining process, in response to determining in the fourth determining process that the liquid reservoir has been replaced.

9. The liquid ejecting apparatus according to claim 1, wherein:
the controller causes the liquid ejecting apparatus to perform a purging process of causing the head to discharge liquid from the nozzle to the receiver; and
at least one of in case where an amount of liquid discharged in the purging process exceeds a predetermined amount or in a case where the number of times the purging process has been performed exceeds a predetermined number of times, the controller causes the liquid ejecting apparatus to determine in the first determining process that the first condition is satisfied.

10. The liquid ejecting apparatus according to claim 1, wherein in a case where the number of recording media on which an image has been recorded in the recording process or an amount of liquid having been used in the recording process exceeds a threshold value, the controller causes the liquid ejecting apparatus to determine in the first determining process that the first condition is satisfied.

11. The liquid ejecting apparatus according to claim 1, wherein at least one of in a case where a duration in which the recording process is not performed exceeds a predetermined time, in a case where the number of recording media on which an image has been recorded in the recording process per unit time is less than a threshold value, or in a case where an amount of liquid having been used in the recording process per unit time is less than a threshold value, the controller causes the liquid ejecting apparatus to determine in the first determining process that the first condition is satisfied.

12. The liquid ejecting apparatus according to claim 1, wherein:
the liquid channel includes a first liquid channel for a first liquid and a second liquid channel for a second liquid;
the nozzle is one of a plurality of nozzles including a first nozzle included in the first liquid channel and a second nozzle included in the second liquid channel;
the receiver includes a first receiver for the first nozzle and a second receiver for the second nozzle;
the recovery channel includes a first recovery channel connecting the first receiver and the first liquid channel and a second recovery channel connecting the second receiver and the second liquid channel;
the liquid ejecting apparatus further comprises a memory; and
the controller causes the liquid ejecting apparatus to perform, in the recording process in which the first liquid is to be ejected from the first nozzle, a control operation corresponding to a determination result of the first determining process performed based on first information stored in the memory, and perform, in the recording process in which the second liquid is to be ejected from the second nozzle, a control operation corresponding to a determination result of the first determining process performed based on second information stored in the memory, the first information being information for determining whether the first condition is satisfied with respect to the first liquid in the first determining process, the second information being information for determining whether the first condition is satisfied with respect to the second liquid in the first determining process.

13. A control method for a liquid ejecting apparatus including a head having a liquid channel including a nozzle, a receiver, and a recovery channel connecting the receiver and the liquid channel, the method comprising:
a recovering process of feeding a liquid from the receiver to the liquid channel via the recovery channel;
a first determining process of determining whether a first condition is satisfied, the first condition representing a first increase of a liquid feeding time required to feed a predetermined amount of liquid to the liquid channel via the recovery channel; and
a recording process of recording an image on a recording medium by causing the head to eject liquid from the nozzle to the recording medium,
wherein, in response to determining in the first determining process that the first condition is satisfied, causing the liquid ejecting apparatus to perform, in the recording process, at least one of:
a first control in which a recording time with respect to a unit area of the recording medium is longer than a recording time with respect to the unit area of a case where the first condition is determined to be not satisfied in the first determining process, or
a second control in which an ejection amount of liquid with respect to the unit area of the recording medium is less than an ejection amount of a case where the first condition is determined to be not satisfied in the first determining process.

14. A non-transitory and computer-readable medium storing a program executable by a controller of a liquid ejecting apparatus, the liquid ejecting apparatus including:
a head having a liquid channel including a nozzle;
a receiver; and
a recovery channel connecting the receiver and the liquid channel,
the program, when executed by the controller, causing the liquid ejecting apparatus to perform:
a recovering process of feeding a liquid from the receiver to the liquid channel via the recovery channel;
a first determining process of determining whether a first condition is satisfied, the first condition representing a first increase of a liquid feeding time required to feed a predetermined amount of liquid to the liquid channel via the recovery channel; and
a recording process of recording an image on a recording medium by causing the head to eject liquid from the nozzle to the recording medium, and
wherein, in response to determining in the first determining process that the first condition is satisfied, the controller causes the liquid ejecting apparatus to perform, in the recording process, at least one of:
first control in which a recording time with respect to a unit area of the recording medium is longer than a recording time with respect to the unit area of a case where the controller determines in the first determining process that the first condition is not satisfied, or
second control in which an ejection amount of liquid with respect to the unit area of the recording medium is less than an ejection amount of a case where the controller determines in the first determining process that the first condition is not satisfied.
